(19) United States
(12) Patent Application Publication
(10) Pub. No.: US 2019/0047001 A1
(43) Pub. Date: Feb. 14, 2019

(54) SPRAY NOZZLE, FILM FORMING DEVICE, AND FILM FORMING METHOD

(71) Applicant: TATSUTA ELECTRIC WIRE & CABLE CO., LTD., Higashiosaka-shi, Osaka (JP)

(72) Inventor: Masaki HIRANO, Kyoto (JP)

(73) Assignee: TATSUTA ELECTRIC WIRE & CABLE CO., LTD., Higashiosaka-shi, Osaka (JP)

(21) Appl. No.: 16/078,084

(22) PCT Filed: Mar. 17, 2017
(86) PCT No.: PCT/JP2017/011049

§ 371 Date: Aug. 21, 2018

(30) Foreign Application Priority Data
Mar. 24, 2016 (JP) 2016-060674

(51) Int. Cl. B05B 7/20; C23C 24/04

(52) U.S. Cl. CPC B05B 7/20; C23C 24/04

(57) ABSTRACT

A spray nozzle, a film forming device, and a film forming method, each facilitate formation of a film in a small region. A spray nozzle includes: a gas entrance section in which a passage of a carrier gas gradually becomes smaller along a flow of the carrier gas; a passage enlargement section in which a passage of the carrier gas gradually becomes larger along a flow of the carrier gas; an opening formation section which has one or more openings via which a passage of the carrier gas and an external space communicate with each other; and a gas exit section in which a passage of the carrier gas gradually becomes smaller along a flow of the carrier gas.

### TECHNICAL FIELD

The present invention relates to a spray nozzle, a film forming device, and a film forming method, each of which is for forming a film on a base material by spraying a film material, together with a carrier gas, onto the base material.

### BACKGROUND ART

In the field of electronics, electrical components and electrical circuits are becoming increasingly reduced in size and weight in recent years. Accordingly, there are increasing demands such as a demand for conducting a surface treatment (surface modification) of a micro-region and a demand for forming an electrode in a micro-region.

In order to meet such demands, great attention has been paid in recent years to a method for forming a film with use of a thermal spray method. For example, a cold spray method, which is a type of thermal spray method, is a method for (1) causing a carrier gas whose temperature is lower than a melting point or a softening temperature of a film material to flow at a high speed, (2) introducing the film material into the flow of the carrier gas and then increasing the speed of the carrier gas into which the film material has been introduced, and (3) forming a film by causing the film material to collide with, for example, a substrate at a high speed while the film material is in a solid phase.

Techniques of forming a film with use of the cold spray method are disclosed in Patent Literatures 1 through 3.

### CITATION LIST

### Patent Literatures

[Patent Literature 1]

Japanese Patent Application Publication, Tokukai, No. 2011-240314 (Publication Date: Dec. 1, 2011)

[Patent Literature 2]

Japanese Patent Application Publication, Tokukai, No. 2005-95886 (Publication Date: Apr. 14, 2005)

[Patent Literature 3]

Japanese Patent Application Publication, Tokukai, No. 2009-120913 (Publication Date: Jun. 4, 2009)

### SUMMARY OF INVENTION

### Technical Problem

The cold spray methods disclosed in Patent Literatures 1 through 3 each use a spray nozzle in which a passage for a carrier gas gradually becomes larger along a flow of the carrier gas. That is, each of the spray nozzles of Patent Literatures 1 through 3 is designed such that an exit of the spray nozzle has a diameter greater than that of an entrance of the spray nozzle. This design is intended for expanding the carrier gas toward the exit of the spray nozzle, so that the carrier gas thus expanded causes a film material to accelerate.

Thus, the spray nozzles of Patent Literatures 1 thorough 3 each have an exit with a diameter greater than that of an entrance, so that masking is separately needed in a case of (i) performing a surface treatment (surface modification) of a region that is smaller than the diameter of the exit and (ii) forming an electrode in the region. For example, a standardized spray nozzle, which is currently in use, has an entrance with a diameter of 2 mm, an exit with a diameter of 5 mm or 6 mm, and a length of 120 mm. As such, in a case of forming a film in a region smaller than the diameter (5 mm or 6 mm) of the exit, it is necessary to perform masking, which is time-consuming and costly.

Meanwhile, it is possible to employ an arrangement in which the diameter of the entrance is unchanged and only the diameter of the exit is reduced. However, this arrangement suppresses expansion of the carrier gas inside the spray nozzle, and accordingly prevents sufficient acceleration of the film material. Thus, employing the above arrangement will result in a decrease in film formation efficiency, and formation of a film in a small region remains difficult.

The present invention is accomplished in view of the aforementioned problem. An object of the present invention is to provide a spray nozzle, a film forming device, and a film forming method each of which facilitates formation of a film in a small region.

### Solution to Problem

In order to attain the object, a spray nozzle in accordance with the present invention is a spray nozzle for spraying a film material, together with a carrier gas, onto a base material so as to form a film on the base material, and is configured such that the spray nozzle includes: a gas entrance section in which a passage of the carrier gas gradually becomes smaller along a flow of the carrier gas; a passage enlargement section which is subsequent to the gas entrance section and in which a passage of the carrier gas gradually becomes larger along a flow of the carrier gas; an opening formation section which is subsequent to the passage enlargement section and has one or more openings via which a passage route of the carrier gas and an external space communicate with each other; and a gas exit section which is subsequent to the opening formation section and in which a passage of the carrier gas gradually becomes smaller along a flow of the carrier gas.

According to the above configuration, in the gas entrance section of the spray nozzle, the passage of the carrier gas gradually becomes smaller along the flow of the carrier gas. This increases a speed of the carrier gas in the gas entrance section.

Further, the spray nozzle includes the passage enlargement section which is subsequent to the gas entrance section. In the passage enlargement section, the passage of the carrier gas gradually becomes larger along the flow of the carrier gas. This causes the carrier gas to expand in the passage enlargement section of the spray nozzle, and the carrier gas thus expanded causes the film material to accelerate.

Further, the spray nozzle includes the opening formation section and the gas exit section. In the gas exit section, the passage of the carrier gas gradually becomes smaller along the flow of the carrier gas. As such, it seems likely that the carrier gas will flow back in the gas exit section so as to interfere with acceleration of the film material.

However, the opening formation section has the one or more openings via which the passage route of the carrier gas and the external space communicate with each other. As such, a portion of the carrier gas is released through the one or more openings. This allows the spray nozzle to reduce a backward flow of the carrier gas in the gas exit section. Accordingly, the spray nozzle is able to spray the film material onto the base material without interference of the acceleration of the base material.

Further, in the spray nozzle, the passage of the carrier gas in the gas exit section gradually becomes smaller along the flow of the carrier gas. This allows an area of an exit of the gas exit section of the spray nozzle to be smaller, as compared with a conventional spray nozzle. Accordingly, the spray nozzle is able to form a film in a small region more easily without a decrease in film formation efficiency.

In order to attain the object, a spray nozzle in accordance with the present invention is a spray nozzle for spraying a film material, together with a carrier gas, onto a base material so as to form a film on the base material, and is configured such that the spray nozzle includes: a gas entrance section in which a passage of the carrier gas gradually becomes smaller along a flow of the carrier gas; a passage enlargement section which is subsequent to the gas entrance section and in which a passage of the carrier gas gradually becomes larger along a flow of the carrier gas, the passage enlargement section having one or more openings via which the passage of the carrier gas and an external space communicate with each other; and a gas exit section which is subsequent to the passage enlargement section and in which a passage of the carrier gas gradually becomes smaller along a flow of the carrier gas.

According to the above configuration, in the gas entrance section of the spray nozzle, the passage of the carrier gas gradually becomes smaller along the flow of the carrier gas. This increases a speed of the carrier gas in the gas entrance section.

Further, the spray nozzle includes the passage enlargement section which is subsequent to the gas entrance section. In the passage enlargement section, the passage of the carrier gas gradually becomes larger along the flow of the carrier gas. This causes the carrier gas to expand in the passage enlargement section of the spray nozzle, and the carrier gas thus expanded causes the film material to accelerate.

Further, the spray nozzle includes the gas exit section. In the gas exit section, the passage of the carrier gas gradually becomes smaller along the flow of the carrier gas. As such, it seems likely that the carrier gas will flow back in the gas exit section so as to interfere with acceleration of the film material.

However, the passage enlargement section has the one or more openings via which the passage route of the carrier gas and the external space communicate with each other. As such, a portion of the carrier gas is released through the one or more openings. This allows the spray nozzle to reduce a backward flow of the carrier gas in the gas exit section. Accordingly, the spray nozzle is able to spray the film material onto the base material without interference of the acceleration of the base material.

Further, in the spray nozzle, the passage of the carrier gas in the gas exit section gradually becomes smaller along the flow of the carrier gas. This allows an area of an exit of the gas exit section of the spray nozzle to be smaller, as compared with a conventional spray nozzle. Accordingly, the spray nozzle is able to form a film in a small region more easily without a decrease in film formation efficiency.

### Advantageous Effects of Invention

According to the present invention, the spray nozzle, the film forming device, and the film forming method of the present invention facilitate formation of a film in a small region.

### BRIEF DESCRIPTION OF DRAWINGS

FIG. 1 is a cross-sectional view of a spray nozzle in accordance with an embodiment.

FIG. 2 is a schematic view of a cold spray device in accordance with the embodiment.

FIG. 3 is a view illustrating a state in which an opening is provided in a terminal end portion of an opening formation section on a gas exit section side.

FIG. 4 is a view illustrating a state in which a plurality of openings are provided in the opening formation section.

FIG. 5 is a view for explaining details of a gas exit section.

FIG. 6 is a view for explaining a flow of a carrier gas in an opening formation section and a gas exit section.

FIG. 7 is a cross-sectional view of a spray nozzle in accordance with another embodiment.

FIG. 8 is an external view of main parts of a spray nozzle in accordance with Example.

FIG. 9 is a cross-sectional view and a bottom view of a passage enlargement section in accordance with the Example.

FIG. 10 is a cross-sectional view and a top view of a gas exit section in accordance with the Example.

FIG. 11 is a cross-sectional view and a top view of an opening formation section in accordance with the Example.

FIG. 12 is a view illustrating a state of film formation achieved with use of the spray nozzle in accordance with the Example.

FIG. 13 is a view illustrating a state of film formation achieved with use of a conventional spray nozzle.

### DESCRIPTION OF EMBODIMENTS

Embodiments are described below with reference to the drawings. In the following description, identical components and identical constituent elements are given respective identical reference signs. Such components and constituent elements are also identical in name and function. Thus, a specific description of those components and constituent elements is not repeated.

### Embodiment 1

Firstly, with reference to FIG. 2, the following description will discuss a cold spray device (film forming device) 100 in which a spray nozzle 1 in accordance with Embodiment 1 is used.

The following description will assume that the spray nozzle 1 is used in a cold spray method. However, the spray nozzle 1 is also applicable to other thermal spray methods (flame spraying, high velocity flame spraying, HVOF, FVAF, plasma spraying, and the like). Further, the cold spray method is roughly classified into high-pressure cold spraying and low-pressure cold spraying, depending on working gas pressures. The cold spray device 1 in accordance with Embodiment 1 and a spray nozzle 10 in accordance with Embodiment 2 can each be applied to both the high-pressure cold spraying and the low-pressure cold spraying.

### Cold Spray

In recent years, a film forming method that is called a cold spray method has been used. The cold spray method is a method for causing a carrier gas whose temperature is lower than a melting point or a softening temperature of a film material to flow at a high speed, introducing the film material into the flow of the carrier gas and then increasing the speed of the carrier gas into which the film material has been introduced, and forming a film by causing the film material to collide with, for example, a substrate at a high speed while the film material is in a solid phase.

A principle of film formation by the cold spray method is understood as below.

A collision speed of not less than a certain critical value is required for a film material to adhere to and accumulate on a substrate so as to form a film. Such a collision speed is referred to as a critical speed. In a case where the film material collides with the substrate at a speed that is less than the critical speed, the substrate is worn, so that small crater-shaped cavities are merely formed in the substrate. The critical speed is changed by, for example, a material, a size, a shape, a temperature, and/or an oxygen content of the film material, or a material of the substrate.

In a case where the film material collides with the substrate at a speed that is not less than the critical speed, plastic deformation caused by a great shearing force occurs near an interface between the film material and the substrate (or the film which has already been formed). The plastic deformation and generation of a great shock wave in a solid due to the collision cause an increase in temperature near the interface, and in this process, solid phase bonding occurs between the film material and the substrate and between the film material and the film (or the film material which has already adhered to the substrate).

Non-limiting examples of the film material can encompass the following materials.

1. Pure metal

Copper (Cu), aluminum (Al), titanium (Ti), silver (Ag), nickel (Ni), zinc (Zn), tin (Sn), molybdenum (Mo), iron (Fe), tantalum (Ta), niobium (Nb), silicon (Si), or chromium (Cr)

2. Low-alloy steel

Ancorsteel 100

3. Nickel chromium alloy

50Ni-50Cr, 60Ni-40Cr, or 80Ni-20Cr

4. Nickel-base superalloy

Alloy625, Alloy718, Hastelloy C, or In738LC

5. Stainless steel

SUS304/304L, SUS316/316L, SUS420, or SUS440

6. Zinc alloy: Zn-20Al
7. Aluminum alloy: A1100 or A6061
8. Copper alloy: C95800 (Ni—AL Bronze) or 60Cu-40Zn

### 9. MCrAlY: NiCrAlY or CoNiCrAlY

10. Other: An amorphous (quasicrystalline) metal, a composite material, a cermet, or a ceramic

### Cold Spray Device 100

FIG. 2 is a view schematically illustrating the cold spray device 100. As illustrated in FIG. 2, the cold spray device 100 includes a tank 110, a heater 120, a spray nozzle 1, a feeder 140, a base material holder 150, and a control device (not illustrated).

The tank 110 stores therein a carrier gas. The carrier gas is supplied from the tank 110 to the heater 120. Examples of the carrier gas include nitrogen, helium, air, or a mixed gas of nitrogen, helium, and air. A pressure of the carrier gas is adjusted so that the pressure is, for example, not less than 70 PSI and not more than 150 PSI (not less than approximately 0.48 Mpa and not more than approximately 1.03 Mpa) at an exit of the tank 110. Note, however, that the pressure of the carrier gas at the exit of the tank 110 does not necessarily need to fall within the above range, and is appropriately adjusted in accordance with, for example, material(s) and/or a size of a film material, and/or material(s) of a substrate.

The heater 120 heats the carrier gas which has been supplied from the tank 110. More specifically, the carrier gas is heated to a temperature that is lower than a melting point of the film material which is supplied from the feeder 140 to the spray nozzle 1. For example, the carrier gas which is subjected to measurement at an exit of the heater 120 is heated to a temperature in a range of not less than 50° C. and not more than 500° C. Note, however, that a heating temperature of the carrier gas does not necessarily need to fall within the above range, and is appropriately adjusted in accordance with, for example, the material(s) and/or the size of the film material, and/or the material(s) of the substrate.

The carrier gas is heated by the heater 120 and then is supplied to the spray nozzle 1.

The spray nozzle 1 (i) causes an increase in speed of the carrier gas which has been heated by the heater 120 to a speed in a range of not less than 300 m/s and not more than 1200 m/s and (ii) causes the carrier gas to be sprayed therethrough onto a base material 20. Note, however, that the speed of the carrier gas does not necessarily need to fall within the above range, and is appropriately adjusted in accordance with, for example, the material(s) and/or the size of the film material, and/or the material(s) of the substrate. Note that the spray nozzle 1 can be replaced with the spray nozzle 10 described in Embodiment 2.

The feeder 140 supplies the film material to the flow of the carrier gas whose speed is increased by the spray nozzle 1. The film material which is supplied from the feeder 140 has a particle size of, for example, not less than 1 μm and not more than 50 μm. Together with the carrier gas, the film material which has been supplied from the feeder 140 is sprayed through the spray nozzle 1 onto the base material 20.

The base material holder 150 fixes the base material 20. Onto the base material 20 which has been fixed by the base material holder 150, the carrier gas and the film material are sprayed through the spray nozzle 1. A distance between a surface of the base material 20 and a tip of the spray nozzle 1 is adjusted so that the distance falls within a range of, for example, not less than 1 mm and not more than 30 mm. In a case where the distance between the surface of the base material 20 and the tip of the spray nozzle 1 is less than 1 mm, a film formation speed is decreased. This is because the carrier gas sprayed from the spray nozzle 1 flows back into the spray nozzle 1. At this time, a pressure generated when the carrier gas flows back may cause a member (e.g., a hose) connected to the spray nozzle 1 to be detached. Meanwhile, in a case where the distance between the surface of the base material 20 and the tip of the spray nozzle 1 is more than 30 mm, efficiency in film formation is decreased. This is because it becomes more difficult for the carrier gas and the film material which have been sprayed from the spray nozzle 1 to reach the base material 20.

Note, however, that the distance between the surface of the base material 20 and the tip of the spray nozzle 1 does not necessarily need to fall within the above range, and is appropriately adjusted in accordance with, for example, the material(s) and/or the size of the film material, and/or the material(s) of the substrate.

The control device controls the cold spray device 100 in accordance with information stored therein in advance and/or an input by an operator. Specifically, the control device controls, for example, (i) the pressure of the carrier gas which is supplied from the tank 110 to the heater 120, (ii) the temperature of the carrier gas which is heated by the heater 120, (iii) a kind and an amount of the film material which is supplied from the feeder 140, and (iv) the distance between the surface of the base material 20 and the spray nozzle 1.

### Spray Nozzle 1

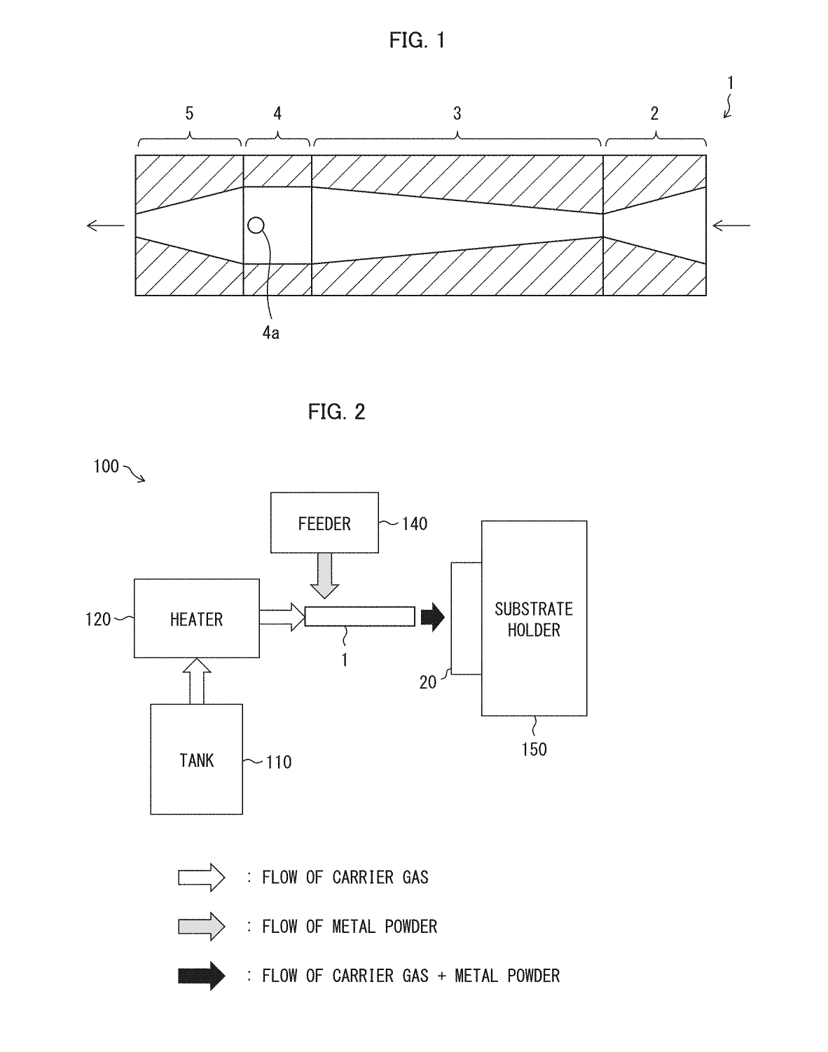

The following description will discuss the spray nozzle 1 with reference to FIG. 1 etc. FIG. 1 is a cross-sectional view of the spray nozzle 1.

The spray nozzle 1 is used for forming a film on the base material 20 by spraying the film material, together with the carrier gas, on the base material 20. The spray nozzle 1 includes a gas entrance section 2, a passage enlargement section 3, an opening formation section 4, and a gas exit section 5.

Note that the gas entrance section 2, the passage enlargement section 3, the opening formation section 4, and the gas exit section 5 may be formed integrally. Alternatively, the gas entrance section 2, the passage enlargement section 3, the opening formation section 4, and the gas exit section 5 may be formed as separate members, and be screwed to each other or detachably connected to each other via a screw or the like (details of screwing etc. are omitted in the drawings). Further, a commercially-available standard spray nozzle can be used, as it is, as each of the gas entrance section 2 and the passage enlargement section 3. The spray nozzle 1 may have an arrangement such as a feed opening to which the film material is fed from the feeder 140, but details of such an arrangement are omitted in the drawings.

A direction in which the carrier gas flows in the spray nozzle 1 is indicated by arrows in FIG. 1 (a right-to-left direction of a drawing sheet of FIG. 1). The carrier gas is supplied to the gas entrance section 2 of the spray nozzle 1 after being heated by the heater 120.

In the gas entrance section 2, a passage of the carrier gas contracts along the flow of the carrier gas. This causes an increase in speed of the carrier gas in the gas entrance section 2.

Subsequent to the gas entrance section 2, the passage enlargement section 3 is provided. In the passage enlargement section 3, a passage of the carrier gas gradually becomes larger along the flow of the carrier gas. Accordingly, in the spray nozzle 1, the carrier gas is expanded in the passage enlargement section 3, and this expansion of the carrier gas causes the film material to accelerate.

Subsequent to the passage enlargement section 3, the opening formation section 4 is provided. In the opening formation section 4, a passage of the carrier gas is constant along the flow of the carrier gas. Note that in the opening formation section 4, the passage of the carrier gas may be constant, become larger, or become smaller, but preferably is constant or becomes larger.

The opening formation section 4 has an opening 4a via which the passage of the carrier gas and an external space communicate with each other. The opening 4a is provided in the vicinity of a terminal end portion of the opening formation section 4 on a gas exit section 5 side. Note that “in the vicinity of a terminal end portion” means around or near the terminal end portion.

### Variations of Opening Provided in Opening Formation Section 4

In FIG. 1, the opening formation section 4 has a single opening 4a. However, the opening formation section 4 may have a plurality of openings. Further, a position and number of opening(s) provided in the opening formation section 4 may vary to a great extent.

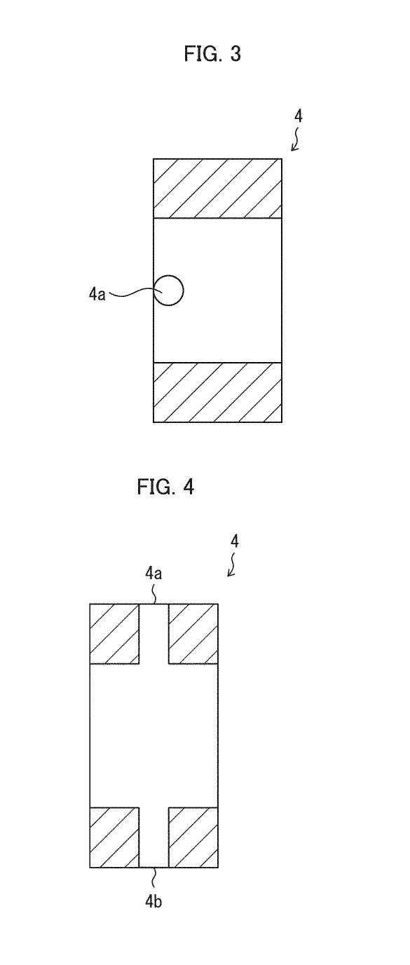

Examples of such variations are described with reference to FIGS. 3 and 4. FIG. 3 is a view illustrating a state in which an opening 4a is provided in the terminal end portion of the opening formation section 4 on the gas exit section 5 side. FIG. 4 is a view illustrating a state in which a plurality of openings are provided in the opening formation section 4.

In FIG. 3, the opening 4a is provided in the terminal end portion of the opening formation section 4 on the gas exit section 5 side. “Terminal end portion” refers to an end portion of the opening formation section 4. In an example illustrated in FIG. 3, the opening 4a is located so as to overlap with the end portion of the opening formation section 4.

In FIG. 4, the opening 4a and an opening 4b are provided in the opening formation section 4. That is, a plurality of openings are provided in the opening formation section 4. Further, in FIG. 4, the opening 4a and the opening 4b are located in a middle portion of the opening formation section 4 in a direction in which the carrier gas flows. However, the opening 4a and the opening 4b may be provided in the terminal end portion of the opening formation section 4 on the gas exit section 5 side, or in the vicinity of the terminal end portion. Further, the opening formation section 4 may have three or more openings. Furthermore, the opening 4a and the opening 4b need not be located so as to face each other, and may instead be located close to each other.

In FIG. 1 etc., each of the opening 4a and the opening 4b has a circular shape. However, the opening 4a and the opening 4b may each have various shapes such as a rectangle, an ellipse, a rhombus, or a trapezoid. Further, the opening 4a and the opening 4b may be provided in a portion of the opening formation section 4 on a passage enlargement section 3 side, instead of being provided in the terminal end portion of the opening formation section 4 on the gas exit section 5 side or in the vicinity of the terminal end portion.

As described above, an opening provided in the opening formation section 4 may vary to a great extent. This also applies to an opening 6a which will be described later.

Subsequent to the opening formation section 4, the gas exit section 5 is provided. In the gas exit section 5, a passage of the carrier gas gradually becomes smaller along the flow of the carrier gas.

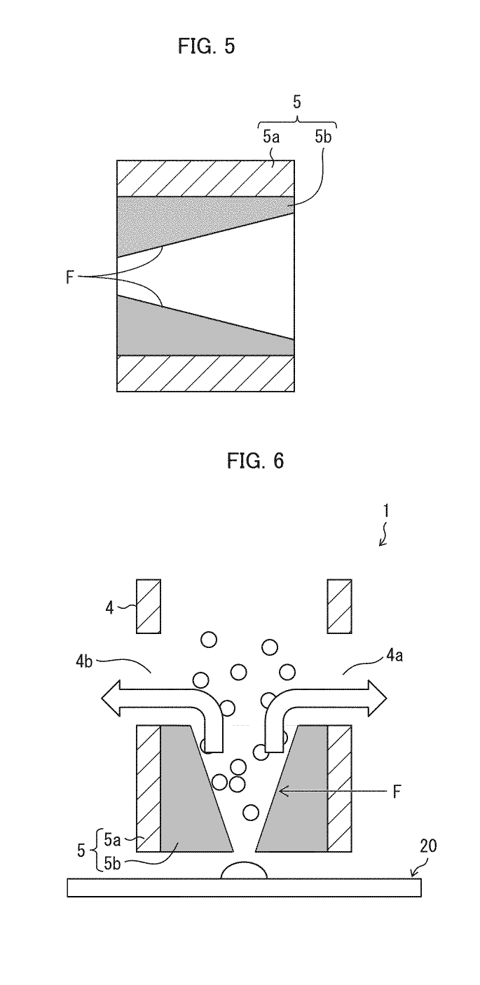

Details of the gas exit section 5 will be described with reference to FIG. 5. FIG. 5 is a view for explaining details of the gas exit section 5.

The gas exit section 5 includes an outer tubular section 5a and a passage definition section 5b. The passage definition section 5b is contained inside the outer tubular section 5a and defines the passage of the carrier gas.

The outer tubular section 5a may be made of a material identical to a material(s) of the gas entrance section 2, the passage enlargement section 3, and/or the opening formation section 4.

In the gas exit section 5, a passage of the carrier gas gradually becomes smaller along the flow of the carrier gas. This is because the passage definition section 5b is arranged such that a width of the passage of the carrier gas gradually becomes smaller along the flow of the carrier gas in the passage definition section 5b. In other words, a shape of the passage definition section 5b defines the passage of the carrier gas.

The passage definition section 5b may be made of a material identical to or different from a material of the outer tubular section 5a. Note that the passage definition section 5b is preferably made of resin. More preferably, the passage definition section 5b is made of a particular resin that has an excellent wear resistance, for example, a fluorine resin such as polytetrafluoroethylene (Teflon (registered trademark)), ultrahigh molecular weight high-density polyethylene, or the like. This is for the following reason.

In a thermal spray method (cold spray method etc.), a carrier gas and a film material flow at a high speed inside a spray nozzle. Since the passage definition section 5b has a tapered shape, the film material collides with a surface F of the passage definition section 5b at a high speed. As such, the surface F of the passage definition section 5b becomes worn easily. In consideration of this, the passage definition section 5b is made of a resin having an excellent wear resistance. This allows extending a service life of the passage definition section 5b. Further, the passage definition section 5b is contained inside the outer tubular section 5a. This arrangement allows the passage definition section 5b to be taken out from the outer tubular section 5a. Accordingly, by preparing various passage definition sections 5b with different cone angles in advance, it is possible to achieve a reduction, on different levels, in size of an area in which a film formation is formed.

In an arrangement illustrated in FIG. 5, the gas exit section 5 is detachable from the opening formation section 4. This allows washing, replacing, or repairing the passage definition section 5b alone as necessary.

Note that the arrangement illustrated in FIG. 5 is an example of the gas exit section 5. As such, in another example, the gas exit section 5 may be provided integrally with the opening formation section 4. Further, the outer tubular section 5a and the passage definition section 5b may be formed integrally.

### Flow of Carrier Gas in Gas Exit Section 5 and Opening Formation Section 4

With reference to FIG. 6, the following description will discuss a flow of the carrier gas in the opening formation section 4 and the gas exit section 5. FIG. 6 is a view for explaining a flow of the carrier gas in the opening formation section 4 and the gas exit section 5. Note that in an example illustrated in FIG. 6, an opening 4a and an opening 4b are provided in the terminal end portion of the opening formation section 4 on the gas exit section 5 side. Further, in FIG. 6, the carrier gas and the film material flow in a top-to-bottom direction of a drawing sheet of FIG. 6.

As illustrated in FIG. 6, since the passage definition section 5b has a tapered shape, the passage of the carrier gas gradually becomes smaller along the flow of the carrier gas in the gas exit section 5. As such, apparently, it seems likely that (1) a flow of the carrier gas flowing in from the gas entrance section 2 side will be blocked by an inclined surface F of the tapered shape of the passage definition section 5b, (2) a portion of the carrier gas will flow back toward the gas entrance section 2 side, and (3) acceleration of the film material in the spray nozzle 1 will be interfered with.

However, the opening formation section 4 has the opening 4a and the opening 4b. As such, a portion of the carrier gas is released to an outside of the spray nozzle 1 through the opening 4a and the opening 4b. This reduces a backward flow of the carrier gas in the spray nozzle 1, and accordingly allows the spray nozzle 1 to spray the film material onto the base material 20 without interference of the acceleration of the base material 20.

Note that in the spray nozzle 1, the passage of the carrier gas in the gas exit section 5 gradually becomes smaller along the flow of the carrier gas. Accordingly, an area of an exit of the gas exit section 5 of the spray nozzle 1 is smaller, as compared with a conventional spray nozzle. This allows the spray nozzle 1 to form a film in a small region more easily as compared with the conventional spray nozzle.

Positions of the opening 4a and the opening 4b provided in the opening formation section 4 do not need to be in the terminal end portion of the opening formation section 4 on the gas exit section 5 side or in the vicinity of the terminal end portion. However, it is preferable that the opening 4a and the opening 4b be located in the terminal end portion of the opening formation section 4 on the gas exit section 5 side or in the vicinity of the terminal end portion. This is because the closer the opening 4a and the opening 4b are located to the gas exit section 5, the greater an effect of reducing the backward flow of the carrier gas in the spray nozzle 1 is when a portion of the carrier gas is released to the outside of the spray nozzle 1 through the opening 4a and the opening 4b.

### Embodiment 2

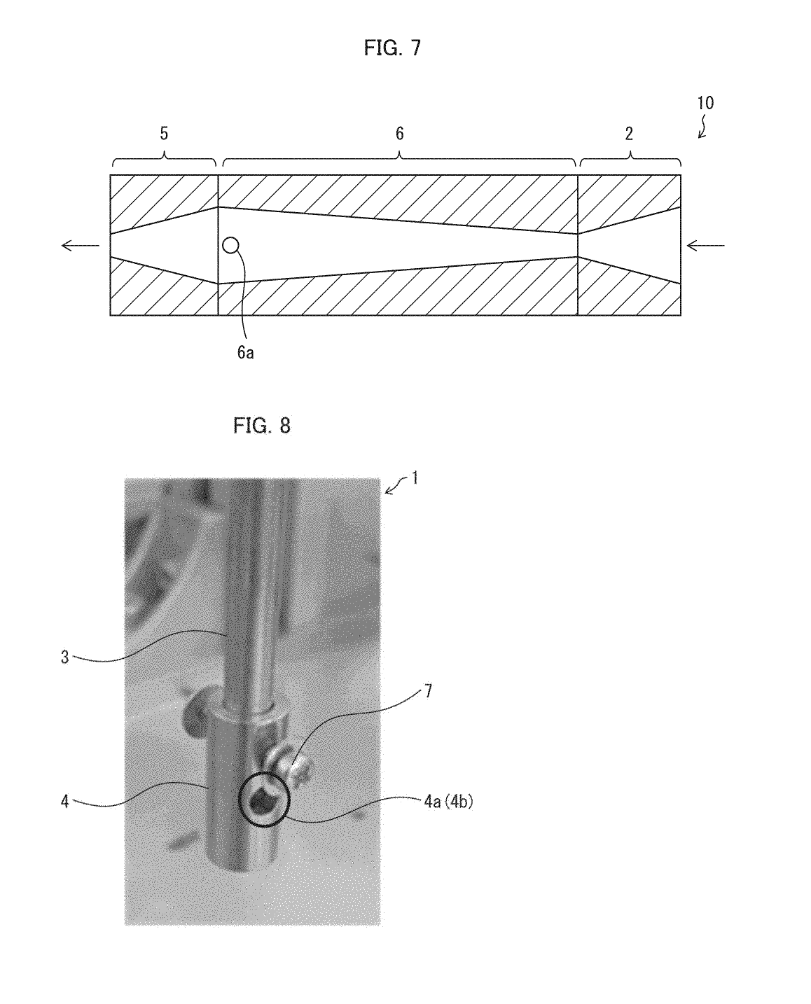

With reference to FIG. 7, the following description will discuss the spray nozzle 10 in accordance with Embodiment 2. FIG. 7 is a cross-sectional view of the spray nozzle 10 in accordance with Embodiment 2. Note that matters already described above will not be repeated.

The spray nozzle 10 includes a gas entrance section 2, a passage enlargement section 6, and a gas exit section 5 in this order in a direction in which the carrier gas flows. The spray nozzle 10 does not have a member equivalent to the opening formation section 4 of the spray nozzle 1. The spray nozzle 10 has an opening 6a in the passage enlargement section 6.

The opening 6a is provided in the vicinity of a terminal end portion of the passage enlargement section 6 on a gas exit section 5 side. “Terminal end portion” refers to an end portion of the passage enlargement section 6. “In the vicinity of a terminal end portion” means around or near the terminal end portion. The opening 6a may be provided in a portion of the passage enlargement section 6 on the gas exit section 5 side, and a position of the portion is not specifically limited. However, it is preferable that the opening 6a be provided in the terminal end portion of the passage enlargement section 6 on the gas exit section 5 side or near the terminal end portion. This is for enhancing an effect of reducing a backward flow of the carrier gas in the spray nozzle 1.

The passage enlargement section 6 may have a plurality of openings. A position, number, and shape of an opening(s) provided in the passage enlargement section 6 may vary to a great extent, as with the opening 4a and the opening 4b described above.

A commercially available standard spray nozzle can be used, as it is, as each of the gas entrance section 2 and the passage enlargement section 6. In that case, however, the commercially available standard spray nozzle needs to be subjected to a process of forming the opening 6a in the passage enlargement section 6.

The gas entrance section 2, the passage enlargement section 6, and the gas exit section 5 may be formed integrally. Alternatively, the gas entrance section 2, the passage enlargement section 6, and the gas exit section 5 may be formed as separate members, and be screwed to each other or detachably connected to each other via a screw or the like (details of screwing etc. are omitted in the drawings). The spray nozzle 10 may have an arrangement such as a feed opening to which the film material is fed from the feeder 140, but details of such an arrangement are omitted in the drawings.

### EXAMPLE

With reference to FIG. 8 etc., the following description will discuss an Example of the spray nozzle 1. FIG. 8 is an external view of main parts of a spray nozzle 1.

FIG. 8 shows a passage enlargement section 3 and an opening formation section 4 of the spray nozzle 1. The opening formation section 4 has an opening 4a and an opening 4b (not illustrated). The passage enlargement section 3 and the opening formation section 4 are fixed to each other via a fixing screw 7. A gas exit section 5, which is not illustrated, is provided inside the opening formation section 4 and is not exposed in FIG. 8.

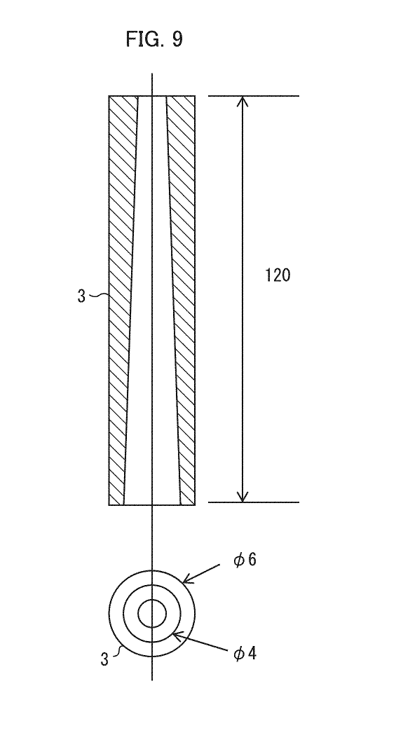

Details of the spray nozzle 1 will be discussed further with reference to FIGS. 9 through 11.

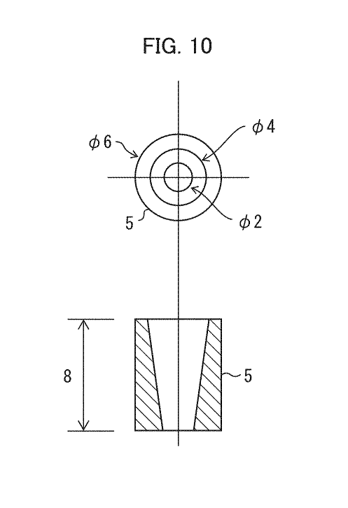

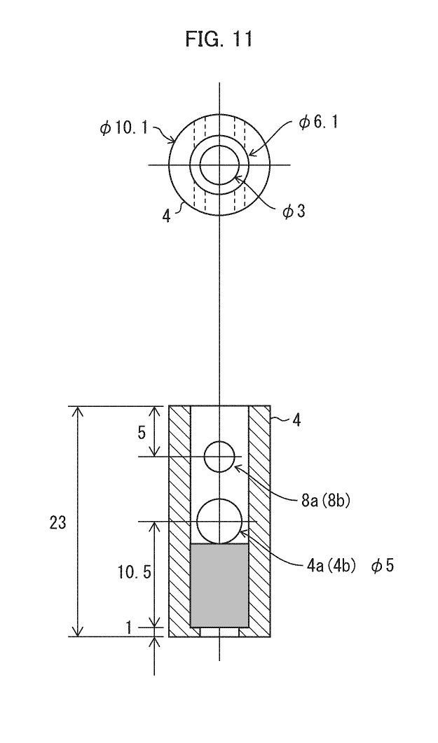

FIG. 9 is a cross-sectional view and a bottom view of the passage enlargement section 3. As illustrated in FIG. 9, a length of the passage enlargement section 3 along a direction in which the carrier gas flows is 120 mm. The passage enlargement section 3 is cylindrical, and has an outer diameter of 6 mm and an inner diameter, on a side from which the carrier gas exits the passage enlargement section 3, of 4 mm. In the passage enlargement section 3, a passage of the carrier gas gradually becomes larger along a flow of the carrier gas. Note that the carrier gas flows from a top-to-bottom direction of a drawing sheet of FIG. 9. This is also the case in FIGS. 10 and 11.

FIG. 10 is a cross-sectional view and a top view of the gas exit section 5. As illustrated in FIG. 10, a length of the gas exit section 5 along a direction in which the carrier gas flows is 8 mm. The gas exit section 5 is cylindrical, and has an outer diameter of 6 mm, an inner diameter of 4 mm on a side from which the carrier gas enters the gas exit section 5, and an inner diameter of 2 mm on a side from which the carrier gas exits the gas exit section 5. In the gas exit section 5, a passage of the carrier gas gradually becomes smaller along a flow of the carrier gas.

FIG. 11 is a cross-sectional view and a top view of the opening formation section 4. As illustrated in FIG. 11, the opening formation section 4 is cylindrical, and a length of the opening formation section 4 along a direction in which the carrier gas flows is 23 mm. The opening formation section 4 has the opening 4a and the opening 4b (not illustrated), each of which is circular. The opening 4a (the opening 4b) is located at a center of the opening formation section 4 in a direction in which the carrier gas flows. The opening 4a (the opening 4b) has a diameter of 5 mm.

Further, the opening formation section 4 has an opening 8a and an opening 8b (not illustrated), each of which is circular. The fixing screw 7, which fixes the passage enlargement section 3 and the opening formation section 4 to each other, is fitted into the opening 8a and the opening 8b. The opening 8a and the opening 8b are positioned so that a center of each of the opening 8a and the opening 8b is located 5 mm away from an end portion of the opening formation section 4 on a side from which the carrier gas enters the opening formation section 4.

As shown in the top view of FIG. 11, the opening formation section 4 is cylindrical, and has an outer diameter of 10.1 mm, an inner diameter of 6.1 mm on the side from which the carrier gas enters the opening formation section 4, and an inner diameter of 3 mm on a side from which the carrier gas exits the opening formation section 4. In the opening formation section 4, a passage of the carrier gas is constant along a flow of the carrier gas.

In the Example, the gas exit section 5 is contained inside the opening formation section 4. In FIG. 11, a hatched portion corresponds to a region in which the gas exit section 5 is contained. That is, in a state where the gas exit section 5 is contained inside the opening formation section 4, the opening 4a and the opening 4b are located in a terminal end portion of the opening formation section 4 on a gas exit section 5 side.

Note that, the Example employs a design in which an exit of the gas exit section 5 is located closer to the passage enlargement section 3 than an exit of the opening formation section 4 is, in the direction in which the carrier gas flows. However, this design is intended for containing the gas exit section 5 inside the opening formation section 4, and has no influence at all on formation of a film of the film material with use of the spray nozzle 1.

### Comparison of Film Formation

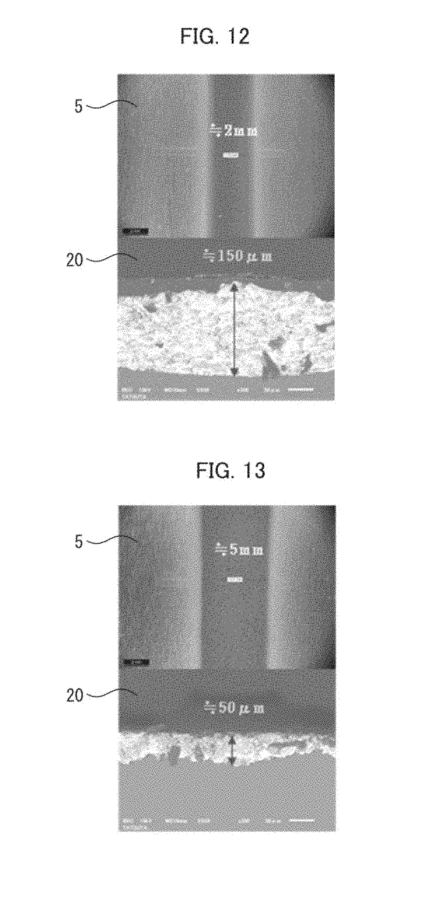

With reference to FIGS. 12 and 13, the following description will make a comparison between a state of film formation achieved with use of the spray nozzle 1 in accordance with the Example and a state of film formation achieved with use of a conventional spray nozzle. FIG. 12 is a view illustrating a state of film formation achieved with use of the spray nozzle 1 in accordance with the Example. FIG. 13 is a view illustrating a state of film formation achieved with use of the conventional spray nozzle.

Note that the conventional spray nozzle refers to a nozzle which is constituted by only the gas entrance section 2 and the passage enlargement section 3. The inner diameter of the gas exit section 5 of the spray nozzle 1 on the side from which the gas exits the gas exit section 5 is 2 mm, whereas an inner diameter of the passage enlargement section 3 of the conventional spray nozzle on a side from which the gas exits the passage enlargement section 3 is 5 mm.

Film formation was conducted under the following conditions.

(1) Base material 20: Al 1050 (thickness: 0.5 mm)
(2) Powder used: mixed powder of Ni and Sn (particle size of Ni: 8 μm, particle size of Sn: 38 μm, mixing ratio of Ni:Sn=90:10)
(3) Set pressure of gas: 140 PSI (0.96 MPa) at an exit of the tank 110
(4) Set temperature of gas: 200° C. at an exit of the heater 120
(5) Distance between the spray nozzle and the base material 20

(a) Conventional nozzle: a distance between a tip portion of the nozzle and the base material 20 was 18 mm

(b) Spray nozzle 1: a distance between a tip portion of the nozzle and the base material 20 was 5 mm

(6) Time of spraying the film material: time during which the film material was sprayed is the same between FIGS. 12 and 13.

An upper photograph of FIG. 12 is a photograph showing a state of an inside of the gas exit section 5. “2 mm” refers to an inner diameter of the gas exit section 5 on a carrier gas exit section side. A portion where the carrier gas exits would, in theory, have a circular shape when photographed, but in reality, the portion has a rectangular shape in the photograph due to being scanned with an imaging lens. This is also the case in an upper photograph of FIG. 13.

As understood from lower photographs in respective FIGS. 12 and 13, in the formation of a film of the film material (mixed powder of Ni and Sn) performed with use of the spray nozzle 1 of the Example (FIG. 12), a thickness of the film material on the base material 20 was approximately 150 μm. Meanwhile, in the formation of a film of the film material (mixed powder of Ni and Sn) performed with use of the conventional spray nozzle (FIG. 13), a thickness of the film material on the base material 20 was approximately 50 μm, which is about ⅓ as compared with the case where the film formation was performed with use of the spray nozzle 1.

This indicates that the spray nozzle 1 of the Example can significantly reduce the use of the film material as compared with the conventional spray nozzle, provided that a thickness of a film formed is the same between the spray nozzle 1 of the Example and the conventional spray nozzle. Note that an amount of the film material that leaked out of the spray nozzle 1 of the Example through the opening 4a and the opening 4b was not large enough to require any consideration of an influence of the leakage on the film formation.

Thus, the spray nozzle 1 of the Example enables both a reduction in size of an area in which a film is formed and a reduction in amount of the film material used, as compared with the conventional spray nozzle.

Note that, in the Example, the gas exit section 5 has an inner diameter of 2 mm on the side from which the gas exits the gas exit section 5. However, the inner diameter of the gas exit section 5 on the side from which the gas exits the gas exit section 5 is not limited to 2 mm, and can be less than 2 mm or more than 2 mm.

### Advantageous Effects of Embodiments 1 and 2

A spray nozzle 1 in accordance with Aspect 1 of the present invention is configured such that the spray nozzle 1 includes: a gas entrance section 2 in which a passage of the carrier gas gradually becomes smaller along a flow of the carrier gas; a passage enlargement section 3 which is subsequent to the gas entrance section 2 and in which a passage of the carrier gas gradually becomes larger along a flow of the carrier gas; an opening formation section 4 which is subsequent to the passage enlargement section 3 and has one or more openings via which a passage of the carrier gas and an external space communicate with each other; and a gas exit section 5 which is subsequent to the opening formation section 4 and in which a passage of the carrier gas gradually becomes smaller along a flow of the carrier gas.

According to the above configuration, in the gas entrance section 2 of the spray nozzle 1, the passage of the carrier gas gradually becomes smaller along the flow of the carrier gas. This increases a speed of the carrier gas in the gas entrance section 2.

Further, the spray nozzle 1 includes the passage enlargement section 3 which is subsequent to the gas entrance section 2. In the passage enlargement section 3, the passage of the carrier gas gradually becomes larger along the flow of the carrier gas. This causes the carrier gas to expand in the passage enlargement section 3 of the spray nozzle 1, and the expansion of the carrier gas causes the film material to accelerate.

Further, the spray nozzle 1 includes the opening formation section 4 and the gas exit section 5. In the gas exit section 5, the passage of the carrier gas gradually becomes smaller along the flow of the carrier gas. As such, it seems likely that the carrier gas will flow back in the gas exit section 5 so as to interfere with acceleration of the film material.

However, the opening formation section 4 has the one or more openings via which the passage route of the carrier gas and the external space communicate with each other. As such, a portion of the carrier gas is released through the one or more openings. This allows the spray nozzle 1 to reduce a backward flow of the carrier gas in the gas exit section 5. Accordingly, the spray nozzle 1 is able to spray the film material onto the base material 20 without interference of the acceleration of the base material.

Further, in the gas exit section 5 of the spray nozzle 1, the passage of the carrier gas gradually becomes smaller along the flow of the carrier gas. This allows an area of an exit of the gas exit section 5 of the spray nozzle 1 to be smaller, as compared with a conventional spray nozzle. Accordingly, the spray nozzle 1 is able to form a film in a small region more easily without a decrease in film formation efficiency.

Further, according to the above configuration, the spray nozzle 1 in accordance with Aspect 1 of the present invention can be applied also to low-pressure cold spraying.

In Aspect 2 of the present invention, the spray nozzle 1 in accordance with Aspect 1 may be configured such that the one or more openings are provided (i) in a terminal end portion of the opening formation section 4 on a gas exit section 5 side or (ii) in the vicinity of the terminal end portion.

According to the above configuration, the spray nozzle 1 can further efficiently suppress a backward flow of the carrier gas. As such, due to having the above configuration, the spray nozzle 1 is capable of forming a film further efficiently while enabling a reduction in size of an area in which a film is formed, as compared with a conventional spray nozzle.

In Aspect 3 of the present invention, the spray nozzle 1 in accordance with Aspect 1 or 2 may be configured such that the gas exit section 5 and the opening formation section 4 are formed integrally and are attachable to and detachable from the passage enlargement section 3.

In the gas exit section 5, the passage of the carrier gas gradually becomes smaller along the flow of the carrier gas. As such, various factors (e.g., the film material, a speed and/or temperature of the carrier gas, and the like) can cause a problem such as (1) clogging of the film material in the gas exit section 5 and (2) deterioration of the gas exit section 5 due to becoming worn.

In this respect, according to the above configuration, the gas exit section 5 and the opening formation section 4 of the spray nozzle 1 are attachable to and detachable from the passage enlargement section 3. As such, in a case where the spray nozzle 1 faces a problem such as the above (1) or (2), the gas exit section 5 and the opening formation section 4 can be removed from the passage enlargement section 3, and the gas exit section 5 in particular can be washed, replaced, or repaired. That is, the spray nozzle 1 does not need replacement of the gas exit section 5 with a new one in a case where a problem such as the above (1) or (2) arises. Accordingly, due to having the above configuration, the spray nozzle 1 enables a reduction in running cost.

In Aspect 4 of the present invention, the spray nozzle 1 in accordance with Aspect 1 or 2 may be configured such that the gas exit section 5 is attachable to and detachable from the opening formation section 4.

According to the above configuration, the gas exit section 5 of the spray nozzle 1 is attachable to and detachable from the opening formation section 4. As such, in a case where the spray nozzle 1 faces a problem such as the above (1) or (2), the gas exit section 5 can be removed from the opening formation section 4, and the gas exit section 5 can be washed, replaced, or repaired. That is, the spray nozzle 1 does not need replacement of the gas exit section 5 with a new one in a case where a problem such as the above (1) or (2) arises. Accordingly, due to having the above configuration, the spray nozzle 1 enables a reduction in running cost.

A spray nozzle 10 in accordance with Aspect 5 of the present invention is a spray nozzle 10 for spraying a film material, together with a carrier gas, onto a base material 20 so as to form a film on the base material 20, and is configured such that the spray nozzle 10 includes: a gas entrance section 2 in which a passage of the carrier gas gradually becomes smaller along a flow of the carrier gas; a passage enlargement section 6 which is subsequent to the gas entrance section 2 and in which a passage of the carrier gas gradually becomes larger along a flow of the carrier gas, the passage enlargement section having one or more openings via which the passage of the carrier gas and an external space communicate with each other; and a gas exit section 5 which is subsequent to the passage enlargement section 6 and in which a passage of the carrier gas gradually becomes smaller along a flow of the carrier gas.

According to the above configuration, in the gas entrance section 2 of the spray nozzle 10, the passage of the carrier gas gradually becomes smaller along the flow of the carrier gas. This increases a speed of the carrier gas in the gas entrance section 2.

Further, the spray nozzle 10 includes the passage enlargement section 6 which is subsequent to the gas entrance section 2. In the passage enlargement section 6, the passage of the carrier gas gradually becomes larger along the flow of the carrier gas. This causes the carrier gas to expand in the passage enlargement section 6 of the spray nozzle 10, and the expansion of the carrier gas causes the film material to accelerate.

Further, the spray nozzle 10 includes the gas exit section 5. In the gas exit section 5, the passage of the carrier gas gradually becomes smaller along the flow of the carrier gas. As such, it seems likely that the carrier gas will flow back in the gas exit section 5 so as to interfere with acceleration of the film material.

However, the passage enlargement section 6 has the one or more openings via which the passage route of the carrier gas and the external space communicate with each other. As such, a portion of the carrier gas is released through the one or more openings. This allows the spray nozzle 10 to reduce a backward flow of the carrier gas in the gas exit section 5. Accordingly, the spray nozzle 10 is able to spray the film material onto the base material 20 without interference of the acceleration of the base material.

Further, in the gas exit section 5 of the spray nozzle 10, the passage of the carrier gas gradually becomes smaller along the flow of the carrier gas. This allows an area of an exit of the gas exit section 5 of the spray nozzle 10 to be smaller, as compared with a conventional spray nozzle. Accordingly, the spray nozzle 10 enables a reduction in size of an area in which a film is formed.

Further, according to the above configuration, the spray nozzle 10 in accordance with Aspect 5 of the present invention can be applied also to low-pressure cold spraying.

In Aspect 6 of the present invention, the spray nozzle 10 in accordance with Aspect 6 may be configured such that the one or more openings are provided (i) in a terminal end portion of the passage enlargement section 6 on a gas exit section 5 side or (ii) in the vicinity of the terminal end portion.

According to the above configuration, the spray nozzle 10 can further efficiently suppress a backward flow of the carrier gas. As such, due to having the above configuration, the spray nozzle 10 is capable of forming a film further efficiently while enabling a reduction in size of an area in which a film is formed, as compared with a conventional spray nozzle.

In Aspect 7 of the present invention, the spray nozzle 10 in accordance with Aspect 5 or 6 may be configured such that the gas exit section 5 is attachable to and detachable from the passage enlargement section 6.

In the gas exit section 5, the passage of the carrier gas gradually becomes smaller along the flow of the carrier gas. As such, various factors (e.g., the film material, a speed and/or temperature of the carrier gas, and the like) can cause a problem such as (1) clogging of the film material in the gas exit section 5 and (2) deterioration of the gas exit section 5 due to becoming worn.

In this respect, the gas exit section 5 of the spray nozzle 1 is attachable to and detachable from the passage enlargement section 6. As such, in a case where the spray nozzle 10 faces a problem such as the above (1) or (2), the gas exit section 5 can be removed from the passage enlargement section 6, and the gas exit section 5 can be washed, replaced, or repaired. That is, the spray nozzle 10 does not need replacement of the gas exit section 5 with a new one in a case where a problem such as the above (1) or (2) arises. Accordingly, the spray nozzle 10 enables a reduction in running cost, as compared with a case in which the gas exit section 5 is not attachable to and detachable from the passage enlargement section 6.

In Aspect 8 of the present invention, the spray nozzle in accordance with Aspect 4 or 7 may be configured such that the gas exit section 5 includes: an outer tubular section 5a; and a passage definition section 5b which is contained inside the outer tubular section 5a and defines a passage of the carrier gas, the passage definition section 5b being attachable to and detachable from the outer tubular section 5a.

According to the above configuration, the passage definition section 5b is attachable to and detachable from the outer tubular section 5a in the spray nozzle. As such, in a case where a problem such as the above (1) or (2) arises, particularly in the passage definition section 5b, the passage definition section 5b can be removed from the outer tubular section 5a, be washed, replaced, or repaired, and then be housed in the outer tubular section 5a. That is, the spray nozzle does not need replacement of the passage definition section 5b with a new one in a case where a problem such as the above (1) or (2) arises. Further, if it is determined that the replacement is necessary, only the passage definition section 5b can be replaced with a new one, and there is no need to replace the gas exit section 5 itself with a new one.

Accordingly, the spray nozzle enables a reduction in running cost, as compared with a case in which the passage definition section 5b is not attachable to and detachable from the outer tubular section 5a.

In Aspect 9 of the present invention, the spray nozzle in accordance with Aspect 8 may be configured such that the passage definition section 5b is made of resin.

Resin is a material which does not easily have friction with the film material. Accordingly, in a case where the passage definition section 5b is made of resin, the passage definition section 5b is prevented from becoming worn, so that a reduction in running cost can be achieved as compared with a case in which, for example, the passage definition section 5b is made of stainless steel.

A cold spray device 100 in accordance with an aspect of the present invention may be configured such that the cold spray device 100 includes the spray nozzle 1 or the spray nozzle 10.

According to the above configuration, the cold spray device 100 is able to form a film in a small region easily.

A film forming method which sprays the film material, together with the carrier gas, through the spray nozzle so as to form a film on the base material may be a film forming method which uses the spray nozzle 1 or the spray nozzle 10, including the step of: spraying the film material, together with the carrier gas, through the spray nozzle 1 or the spray nozzle 10 so as to form a film on the base material 20.

According to the above configuration, the film forming method provides an effect similar to that of a case where the spray nozzle is used. That is, the film forming method is able to form a film in a small region easily as compared with a conventional spray nozzle.

In Aspect 11 of the present invention, the film forming method in accordance with Aspect 11 may be configured such that the film forming meth od is used in a thermal spray method

According to the above configuration, it is possible to achieve a reduction in size of an area in which a film is formed in the thermal spray method. Note here that the thermal spray method is a type of coating technique which forms a film by (i) melting or softening a film material by heating, (ii) microparticulating and accelerating the film material so that the film material collides with a surface of a base material so as to be crushed and flattened, and (iii) solidifying and accumulating particles of the film material. There are many types of thermal spraying, and the configuration above allows the film forming method to be applied to the thermal spray methods in general.

### Remark 1

A tip structure of a spray nozzle in accordance with an aspect of the present invention can be expressed as follows.

A tip structure of a spray nozzle for spraying a film material, together with a carrier gas, onto a base material so as to form a film on the base material, the spray nozzle including: a gas entrance section in which a passage of the carrier gas gradually becomes smaller along a flow of the carrier gas; and a passage enlargement section which is subsequent to the gas entrance section and in which a passage of the carrier gas gradually becomes larger along a flow of the carrier gas, the tip structure including: an opening formation section which is subsequent to the passage enlargement section and has one or more openings via which a passage of the carrier gas and an external space communicate with each other; and a gas exit section which is subsequent to the opening formation section and in which a passage of the carrier gas gradually becomes smaller along a flow of the carrier gas.

### Remark 2

As described above, the cold spray method involves forming a film by causing metallic powder to collide with, for example, a substrate at a high speed while the metallic powder is in a solid phase. As a result, metal particles remains in a metal film. Accordingly, in a case where the metal particles are present in the metal film, it is possible to assume that the metal film has been formed by the cold spray method. Meanwhile, in flame spraying, arc spraying, plasma spraying, or the like, metallic powder is melted and then sprayed onto a substrate. As a result, metal particles rarely remain in a metal film.

Accordingly, a person skilled in the art would be able to tell whether or not a metal film has been formed by the cold spray method, on the basis of a cross-section of the metal film.

### Remark 3

It is impossible or impractical that a metal film formed by the cold spray method can be identified directly on the basis of a structure or a characteristic of the metal film.

Firstly, considering that metal materials to be used vary in structure and characteristic resulting from the structure, it is impossible that a metal film formed by the cold spray method can be defined by specific words. Secondly, no words exist that allow a metal film formed by the cold spray method to be defined clearly in terms of structure and characteristics. Thirdly, it is impossible or impractical that a metal film formed by the cold spray method can be identified by certain words through measurement of the metal film and analysis based on the measurement. This is because, in order for an indicator for identifying any characteristic to be discovered through (i) numerous repetitions of difficult operation and measurement and (ii) statistical processing of obtained data, an enormous amount of trials and errors is required, which is very impractical.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 10: spray nozzle
2: gas entrance section
3, 6: passage enlargement section
4: opening formation section
5: gas exit section
4a, 4b, 6a, 8a, 8b: opening
5a: outer tubular section
5b: passage definition section
7: fixing screw
20: base material
100: cold spray device
110: tank
120: heater
140: feeder
150: base material holder

1. A spray nozzle to be applied to a film forming device which sprays a film material, together with a carrier gas, onto a base material so as to form a film on the base material, comprising:
a gas entrance section in which a passage of the carrier gas gradually becomes smaller along a flow of the carrier gas;
a passage enlargement section which is subsequent to the gas entrance section and in which a passage of the carrier gas gradually becomes larger along a flow of the carrier gas;
an opening formation section which is subsequent to the passage enlargement section and has one or more openings via which a passage of the carrier gas and an external space communicate with each other; and
a gas exit section which is subsequent to the opening formation section and in which a passage of the carrier gas gradually becomes smaller along a flow of the carrier gas.

2. The spray nozzle as set forth in claim 1, wherein the one or more openings are provided (i) in a terminal end portion of the opening formation section on a gas exit section side or (ii) in the vicinity of the terminal end portion.

3. The spray nozzle as set forth in claim 1, wherein the gas exit section and the opening formation section are formed integrally and are attachable to and detachable from the passage enlargement section.

4. The spray nozzle as set forth in claim 1, wherein the gas exit section is attachable to and detachable from the opening formation section.

5. A spray nozzle to be applied to a film forming device which sprays a film material, together with a carrier gas, onto a base material so as to form a film on the base material, comprising:
a gas entrance section in which a passage of the carrier gas gradually becomes smaller along a flow of the carrier gas;
a passage enlargement section which is subsequent to the gas entrance section and in which a passage of the carrier gas gradually becomes larger along a flow of the carrier gas, the passage enlargement section having one or more openings via which the passage of the carrier gas and an external space communicate with each other; and
a gas exit section which is subsequent to the passage enlargement section and in which a passage of the carrier gas gradually becomes smaller along a flow of the carrier gas.

6. The spray nozzle as set forth in claim 5, wherein the one or more openings are provided (i) in a terminal end portion of the passage enlargement section on a gas exit section side or (ii) in the vicinity of the terminal end portion.

7. The spray nozzle as set forth in claim 5, wherein the gas exit section is attachable to and detachable from the passage enlargement section.

8. The spray nozzle as set forth in claim 4, wherein the gas exit section includes:
an outer tubular section; and
a passage definition section which is contained inside the outer tubular section and defines a passage of the carrier gas,
the passage definition section being attachable to and detachable from the outer tubular section.

9. The spray nozzle as set forth in claim 8, wherein the passage definition section is made of resin.

10. A film forming device comprising a spray nozzle recited in claim 1.

11. A film forming method which uses a spray nozzle recited in claim 1, comprising the step of:
spraying the film material, together with the carrier gas, through the spray nozzle so as to form a film on the base material.

12. The film forming method as set forth in claim 11, wherein the film forming method is used in a thermal spray method.
